(19) United States
(12) Patent Application Publication
(10) Pub. No.: US 2014/0291318 A1
(43) Pub. Date: Oct. 2, 2014

(54) MICROWAVE HEATING APPARATUS

(71) Applicant: Tokyo Electron Limited, Tokyo (JP)

(72) Inventors: Kouji SHIMOMURA, Yamanashi (JP); Junichi KITAGAWA, Yamanashi (JP); Nobuhiko YAMAMOTO, Yamanashi (JP); Hiroyuki HAYASHI, Yamanashi (JP); Sumi TANAKA, Yamanashi (JP)

(73) Assignee: Tokyo Electron Limited, Tokyo (JP)

(21) Appl. No.: 14/219,981

(22) Filed: Mar. 19, 2014

(30) Foreign Application Priority Data
Mar. 27, 2013 (JP) 2013-067160

(51) Int. Cl. H05B 6/64

(52) U.S. Cl. CPC H05B 6/642; H05B 6/645
USPC 219/757

(57) ABSTRACT

A microwave heating apparatus is provided to perform heat treatment on a substrate to be processed by irradiating a microwave to the substrate in a processing chamber. The microwave heating apparatus includes a supporting table configured to support the substrate in the processing chamber, a microwave introducing unit configured to introduce the microwave into the processing chamber, a coolant channel formed in the supporting table, and a coolant supply source configured to supply a coolant to the coolant channel. At least a surface of the supporting table which supports the substrate is made of a material in which a product of a relative dielectric constant and a dielectric loss angle is smaller than 0.005, and the coolant supplied from the coolant supply source is liquid having no electrical polarity.

### CROSS-REFERENCE TO RELATED APPLICATIONS

This application claims priority to Japanese Patent Application No. 2013-067160 filed on Mar. 27, 2013, the entire contents of which are incorporated herein by reference.

### FIELD OF THE INVENTION

The present invention relates to a microwave heating apparatus for performing heat treatment on a substrate to be processed by introducing a microwave into a processing chamber.

### BACKGROUND OF THE INVENTION

For example, when semiconductor devices are manufactured, ions as impurities are implanted into a silicon substrate, and amorphous silicon, which is generated on a substrate surface by crystal defects due to the ion implantation, is restored and crystallized. Also, a diffusion layer is formed on a top surface of the silicon substrate. As for the heat treatment performed at this time, there is generally used flash annealing for irradiating light having a pulse width of, e.g., a few millisecond order, by using a lamp heater or so-called RTA (Rapid Thermal Annealing) for irradiating light for a few seconds to several tens of seconds. In the heat treatment using RTA, the substrate temperature reaches about 800° C. to 1100° C.

Recently, along with the trend toward miniaturization of semiconductor devices, it is required to form a thin diffusion layer by reducing a depth of the diffusion layer in a thickness direction of a substrate. Since, however, the heat treatment using RTA is performed at a high temperature of about 900° C., it is difficult to obtain a desired thin diffusion layer due to the diffusion of the impurities. In order to reduce the depth of the diffusion layer, it is considered to suppress the diffusion of impurities by decreasing the temperature of the heat treatment. However, in that case, the impurities are not sufficiently activated and the electrical resistance of the diffusion layer is increased.

To that end, a heating method using a microwave is proposed recently. By performing heating using a microwave, the microwave directly acts on the ions as impurities, which makes it possible to activate the impurities at a lower temperature than in the RTA while suppressing the diffusion of the diffusion layer. As a result, a thin diffusion layer can be formed.

A heating apparatus capable of forming a desired thin diffusion layer by using a microwave is disclosed in, e.g., Japanese Patent Application Publication No. 2012-191158 and corresponding U.S. Patent Application Publication No. 2012/0211486. In this heating apparatus, a substrate is mounted on supporting pins in a processing chamber, and a temperature of the substrate is measured while performing heating by irradiating a microwave to the substrate. Further, the temperature of the substrate is controlled by controlling the amount of a cooling gas supplied to the processing chamber based on the measured substrate temperature.

However, when the substrate is cooled by using the gas, a large amount of gas is consumed. Therefore, the running cost of the heating apparatus is increased.

As for a unit for cooling a substrate without using a gas, there may be used, e.g., a unit for cooling the supporting table that supports the entire backside of the substrate instead of the supporting pins. However, when the supporting table is made of ceramic that is generally used for a conventional substrate supporting table, a microwave is absorbed by the ceramic. In that case, the supporting table itself emits heat, so that it is difficult to properly cool the substrate.

The supporting table may be made of metal other than ceramic. However, if the substrate is in contact with metal, the substrate may be contaminated by so-called contaminants such as metal ions or the like. Further, when the supporting table made of metal is used, it is difficult to ensure the uniformity of the microwave irradiated to the substrate due to the reflection of the microwave at the supporting table.

### SUMMARY OF THE INVENTION

In view of the above, the present invention provides a microwave heating apparatus capable of effectively cooling a substrate to be processed during heat treatment for heating the substrate to be processed by introducing a microwave into a processing chamber.

In accordance with an embodiment of the present invention, there is provided a microwave heating apparatus for performing heat treatment on a substrate to be processed by irradiating a microwave to the substrate in a processing chamber, the microwave heating apparatus including: a supporting table configured to support the substrate in the processing chamber; a microwave introducing unit configured to introduce the microwave into the processing chamber; a coolant channel formed in the supporting table; and a coolant supply source configured to supply a coolant to the coolant channel. At least a surface of the supporting table which supports the substrate is made of a material in which a product of a relative dielectric constant and a dielectric loss angle is smaller than 0.005, and the coolant supplied from the coolant supply source is liquid having no electrical polarity.

### BRIEF DESCRIPTION OF THE DRAWINGS

The objects and features of the present invention will become apparent from the following description of embodiments, given in conjunction with the accompanying drawings, in which:

FIG. 1 is a schematic vertical cross sectional view of a microwave heating apparatus in accordance with an embodiment of the present invention;

FIG. 2 is a cross sectional view schematically showing a structure of a shaft;

FIG. 3 is an explanatory view schematically showing a configuration of a microwave unit;

FIG. 4 is an explanatory view schematically showing a configuration of a power supply unit;

FIG. 5 is a bottom view showing a bottom surface of a ceiling plate of a processing chamber;

FIG. 6 is an explanatory view showing a shape of an opening of the ceiling plate; and

FIG. 7 is a vertical cross sectional view schematically showing a configuration around a supporting table in accordance with another embodiment of the present invention.

### DETAILED DESCRIPTION OF THE EMBODIMENTS

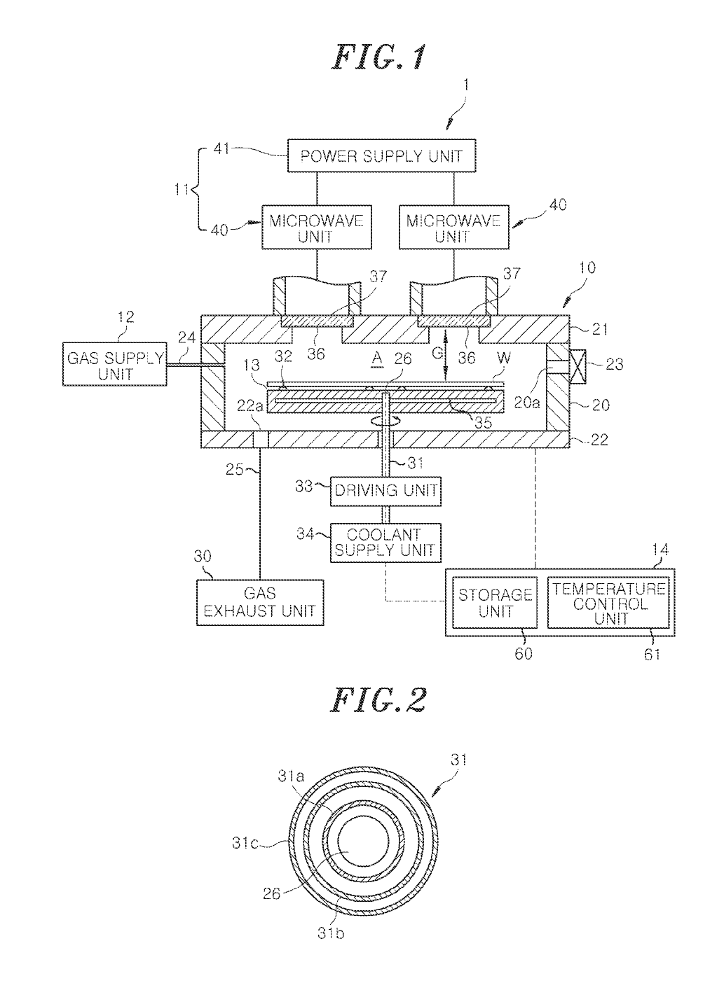

Hereinafter, embodiments of the present invention will be described with reference to the accompanying drawings. Further, like reference numerals will be used for like parts having substantially the same functions throughout the specification and the drawings, and redundant description thereof will be omitted. FIG. 1 is a vertical cross sectional view schematically showing a microwave heating apparatus 1 in accordance with an embodiment of the present invention. Further, in the present embodiment, the case in which a semiconductor wafer (hereinafter, referred to as “wafer”) as a substrate is heated by the microwave heating apparatus 1 will be described as an example. Moreover, a wafer W of the present embodiment is, e.g., a silicon substrate, and has an amorphous silicon layer formed thereon by crystal defects due to implantation of ions as impurities.

As shown in FIG. 1, the microwave heating apparatus 1 includes a processing chamber 10 for accommodating a wafer W as a substrate to be processed, a microwave introducing unit 11 for introducing a microwave into the processing chamber 10, a gas supply unit 12 for supplying a predetermined gas into the processing chamber 10, a supporting table 13 for supporting the wafer W in the processing chamber 10, and a control unit 14 for controlling each unit of the microwave heating apparatus 1. The processing chamber 10 is made of metal, e.g., aluminum, stainless steel or the like.

The processing chamber 10 is, e.g., a substantially rectangular parallelepiped container as a whole. The processing chamber 10 has a substantially square tubular sidewall 20 in a plan view, a substantially square ceiling plate 21 for covering the upper end of the sidewall 20, and a substantially square bottom plate 22 for covering the lower end of the sidewall 20. A processing space A of the processing chamber 10 is formed in a region surrounded by the sidewall 20, the ceiling plate 21, and the bottom plate 22. Further, the surfaces of the sidewall 20, the ceiling plate 21, and the bottom plate 22 which face the processing space A are mirror-processed and serve as reflective surfaces for reflecting the microwave. Accordingly, the heat treatment temperature of the wafer W can be increased compared to a case where they are not mirror-processed.

A loading/unloading port 20a for a wafer W is formed in the sidewall 20 of the processing chamber 10. A gate valve 23 is provided at the loading/unloading port 20a and is opened and closed by a driving unit (not shown). A seal member (not shown) for preventing leakage of the microwave is provided between the gate valve 23 and the sidewall 20. Further, the gas supply unit 12 is connected to the sidewall 20 of the processing chamber 10 through a supply line 24. Moreover, for example, nitrogen gas, argon gas, helium gas, neon gas, hydrogen gas or the like, is supplied from the gas supply unit 12 as a processing gas or a cooling gas.

A gas exhaust port 22a is formed in the bottom plate 22 of the processing chamber 10, and a gas exhaust unit 30, e.g., a vacuum pump or the like, is connected to the gas exhaust port 22a through a gas exhaust line 25.

A shaft 31 that vertically penetrates through the center of the bottom plate 22 and extends to the outside of the processing chamber 10 is provided at the central portion of the supporting table 13. The supporting table is supported by the shaft 31. A plurality of supporting pins 32 is provided at the top surface of the supporting table 13 and serves to contact and support the wafer W. A driving unit 33 for rotating and vertically moving the shaft 31 is connected to the shaft 31 at a position above the lower end of the shaft 31 and outside the processing chamber 10. The vertical position of the wafer W in the processing chamber 10 is adjusted by vertically moving the supporting table 13 which supports the wafer W by the driving unit 33. Further, a coolant supply unit 34 (coolant supply source) is connected to the lower end of the shaft 31. The coolant supply unit 34 is formed by combining a chiller (not shown) for cooling a coolant, a pump (not shown) for force-feeding the coolant to a coolant channel 35 to be described later, a flow rate control valve (not shown) for controlling a flow rate of the coolant supplied to the coolant channel 35, and the like. Further, a space between the shaft 31 and the bottom plate 21 is airtightly sealed by a seal member (not shown). Moreover, the wafer W may be directly mounted on the top surface of the supporting table 13 instead of being supported by the supporting pins 32.

Liquid having no electrical polarity is used as the coolant, which is supplied by the coolant supply unit 34. The liquid having no electrical polarity does not absorb a microwave, so that the temperature increase due to dielectric heating of the microwave can be minimized. The liquid having no polarity may be, e.g., perfluoropolyether (PFPE), as fluorine organic liquid. In that case, the temperature increase of the coolant depends only on the heat exchange with the supporting table 13, so that the wafer W can be stably cooled.

The supporting table 13 is made of a material which makes the increase in temperature small when it is heated by dielectric heating. In other words, the supporting table 13 is made of a material that transmits the microwave (hardly absorbs the microwave). The temperature increase by the dielectric heating is in direct proportion to the product of a relative dielectric constant and a dielectric loss angle of a material. The present inventors have found that the heat emission of the supporting table 13 can be suppressed without disturbing the cooling of the wafer W by using a material in which the aforementioned product is smaller than 0.005 and more preferably equal to or smaller than 0.001. The supporting table 13 of the present embodiment is made of quartz that is a material in which the aforementioned product is smaller than 0.005. Therefore, the supporting table 13 transmits most of the microwave irradiated to the wafer W. As a result, it is possible to suppress the heat emission from the supporting table 13 or the non-uniform distribution of the electric field in the region near the wafer W which is caused by the reflection of the microwave at the supporting table 13. Further, the supporting table 13 needs to endure the heat treatment temperature of the wafer W. Since the heat treatment temperature of the wafer W is about 200° C. to 850° C. depending on purposes, the supporting table 13 is preferably made of a material having a heat resistance temperature of about 900° C. or above. The heat resistance temperature of quartz satisfies such a condition. Further, a material, other than quartz, in which the product of the relative dielectric constant and the dielectric loss angle is smaller than about 0.005 may be, e.g., Teflone (Registered Trademark), polystyrene or the like. Since, however, Teflone (Registered Trademark) or polystyrene has a heat resistance temperature of about 200° C. which is lower than that of quartz, the material such as Teflone (Registered Trademark) or polystyrene can be used for the supporting table 13 in the case of performing the heat treatment at a low temperature.

A coolant channel 35 for supplying a coolant is formed in the supporting table 13. The coolant channel 35 is formed by cutting the inner portion of the supporting table 31. The coolant channel 35 is not necessarily formed by cutting, and may be formed by any method as long as it is made of a material that endures a predetermined temperature and transmits the microwave as in the case of the supporting table 13. Moreover, the coolant channel 35 may be arranged to effectively cool the entire surface of the wafer W. For example, the coolant channel 35 may be arranged in a spiral shape or a zigzag shape in a plan view.

As shown in the cross sectional view of FIG. 2, the shaft 31 has a plurality of coaxial tubes having different diameters. In the present embodiment, the shaft 31 has, e.g., three coaxial tubes 31a to 31c. A temperature measurement unit 26 for measuring a temperature of the wafer W is provided inside the innermost coaxial tube 31a. As for the temperature measurement unit 26, a non-contacting type thermometer such as a radiation thermometer or the like is used. The temperature measured by the temperature measurement unit 26 is input to the control unit 14 and used for controlling the heating of the wafer W by the microwave.

The coolant supplied from the coolant supply unit 34 flows in the intermediate coaxial tube 31b and the outermost coaxial tube 31c. A communication line (not shown) communicating with the coolant channel 35 of the supporting table 13 is provided at each of the coaxial tubes 31b and 31c and can allow the supply of the coolant to the coolant channel 35 and the return of the coolant from the coolant channel 35 to the coolant supply unit 34. In that case, a cooling system for circulating the coolant is formed by the coolant supply unit 34, the coolant channel 35 and the coaxial tubes 31b and 31c. Further, it is possible to arbitrarily set which of the coaxial tubes 31b and 31c is to be used for the coolant supply or the coolant return.

Openings 36 serving as a microwave introduction port for introducing a microwave into the processing chamber 10 are formed in the ceiling plate 21 of the processing chamber 10. A transmission window 37 is provided to block each of the openings 36. The microwave introducing unit 11 is provided above the transmission window 37. The microwave introducing unit 11 has a microwave unit 40 for generating a microwave and a power supply unit 41 connected to the microwave unit 40. In the present embodiment, there are provided, e.g., four transmission windows 37 and four microwave units 40 and one power supply unit 41.

The transmission window 37 is made of a dielectric material, e.g., quartz, ceramic or the like. A gap between the transmission window 37 and the ceiling plate 21 is airtightly sealed by a seal member (not shown). Further, a distance G between the bottom surface of the transmission window 37 and the wafer W heated in the processing chamber is set to, e.g., about 25 mm to 50 mm, in view of suppressing direct irradiation of the microwave to the wafer W. The specific arrangement of the transmission windows 37 will be described later.

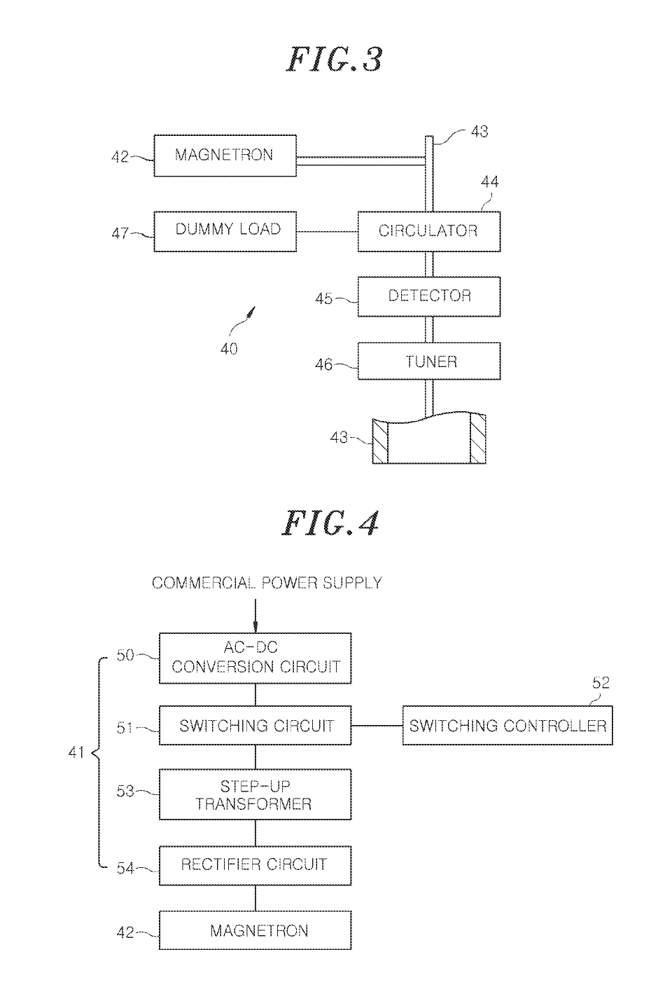

As shown in FIG. 3, the microwave unit 40 includes a magnetron 42 for generating a microwave; a waveguide 43 for transmitting a microwave; a circulator 44, a detector 45 and a tuner 46 which are provided on the waveguide 43 between the magnetron 42 and the transmission window 37; and a dummy load 47 connected to the circulator 44.

The magnetron 42 has an anode and a cathode (not shown) for applying a high voltage to the power supply unit 41. As for the magnetron 42, one capable of oscillating microwaves of various frequencies may be used. As for the frequency of the microwave generated by the magnetron, a frequency suitable for the processing of the wafer W as a substrate to be processed is selected. For example, in the heat treatment, a microwave having a high frequency of about 2.45 GHz or higher is preferably used, and a microwave having a frequency of about 5.8 GHz is more preferably used.

The waveguide 43 has a rectangular cross section and a tubular shape. The waveguide 43 extends upward from the top surfaces of the transmission window 37 and the ceiling plate 21 of the processing chamber 10. The magnetron 42 is connected to an upper end portion of the waveguide 43. The microwave generated by the magnetron 42 is transmitted into the processing space A of the processing chamber 10 through the waveguide 43 and the transmission window 37.

The circulator 44, the detector 45 and the tuner 46 are provided in that order from the upper end of the waveguide 43 toward the lower end thereof. The circulator 44 and the dummy load 47 serve as isolators for separating the reflected wave of the microwave introduced into the processing chamber 10. In other words, the reflected wave from the processing chamber 10 is transmitted to the dummy load 47 by the circulator 44, and the dummy load 47 converts the reflected wave transmitted by the circulator 44 into heat.

The detector 45 detects the reflected wave from the processing chamber 10 in the waveguide 43. The detector 45 has, e.g., an impedance monitor, more specifically a stationary wave monitor for detecting an electric field of the stationary wave in the waveguide 43. The detector 45 may have, e.g., a directional coupler capable of detecting a travelling wave and a reflected wave.

The tuner 46 adjusts an impedance, and the impedance between the magnetron 42 and the processing chamber 10 is matched by the tuner 46. The impedance matching by the tuner 46 is performed based on the detection result of the reflected wave in the detector 45.

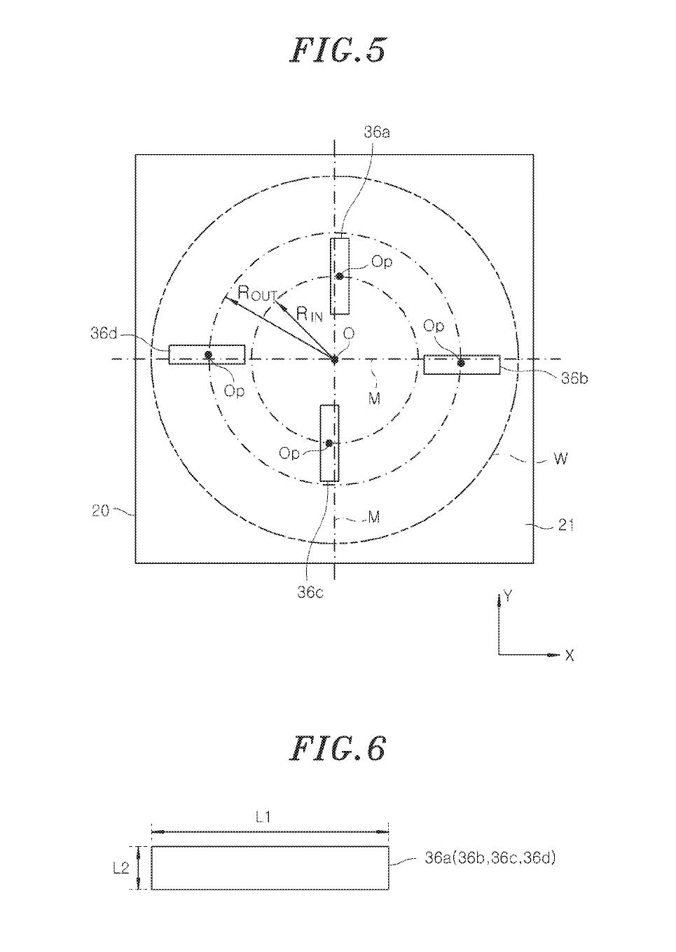

The power supply unit 41 applies a high voltage for generating a microwave to the magnetron 42. As shown in FIG. 4, the power supply unit 41 has an AC-DC conversion circuit connected to a commercial power supply, a switching circuit 51 connected to the AC-DC conversion circuit 50, a switching controller 52 for controlling an operation of the switching circuit 51, a step-up transformer 53 connected to the switching circuit 51, and a rectifier circuit 54 connected to the step-up transformer 53. The step-up transformer 53 and the magnetron 42 are connected through the rectifier circuit 54.

In the AC-DC conversion circuit 50, a three-phase AC voltage of 200V from the commercial power supply is rectified and converted into a DC voltage. The switching circuit 51 controls ON/OFF of the DC converted by the AC-DC conversion circuit 50. In the switching circuit 51, PWM (Pulse Width Modulation) or PAM (Pulse Amplitude Modulation) is performed by the switching controller 52, and a pulsed voltage is produced. The pulsed voltage output from the switching circuit 51 is boosted by the step-up transformer 53. The boosted pulsed voltage is rectified by the rectifier circuit 54 and then supplied to the magnetron 42.

Hereinafter, the arrangement of the openings 36 which are formed in the ceiling plate 21 and serve as the microwave introduction port will be described. FIG. 5 shows the ceiling plate 21 seen from the bottom. In FIG. 5, “O” indicates the center of the wafer and the ceiling plate 21. Further, “M” indicates a line connecting middle points of the opposite sides among the four sides serving as the boundary between the ceiling plate 21 and the sidewall 20. It is not essential that the center of the wafer W and the center of the ceiling plate 21 coincide with each other.

As shown in FIG. 5, four openings 36a to 36d formed in the ceiling plate 21 are arranged in a substantially cross shape along central lines M. As shown in FIGS. 5 and 6, each of the openings 36a to 36d is formed to have a rectangular shape and a ratio between a long side L1 and a short side L2 is set to be, e.g., in a range from 2 to 100 and preferably in a range from 5 to 20. The ratio between the long side L1 and the short side L2 is set to be greater than or equal to 2 to increase the directivity of the microwave irradiated through the openings 36a to 36d into the processing chamber 10 in a direction perpendicular to the long sides of the openings 36a to 36d. When the ratio between the long side L1 and the short side L2 is smaller than 2, the directivity of the microwave is increased in a vertical direction toward the wafer W from the openings 36a to 36d. Therefore, when the distance G between the transmission window 37 and the wafer W is short, the microwave is directly irradiated to a part of the wafer W and the temperature of the wafer W is locally increased. Meanwhile, when the ratio between the long side L1 and the short side L2 is greater than 20, the directivity of the microwave in the vertical direction or in a direction parallel to the long sides of the openings 36a to 36d is excessively decreased, which results in deterioration of the heating efficiency of the wafer W.

Further, the long side L1 of each of the openings 36a to 36d is preferably set to, e.g., L1=n×Ag/2 (n being a positive integer) with respect to a wavelength (Ag) in the waveguide 43. The openings 36a to 36d may have different sizes, or the ratio between the lengths L1 and L2 may be different in each of the openings 36a to 36d. However, in view of performing uniform heat treatment by irradiating the microwave to the wafer W, it is preferable that the openings 36a to 36d have the same size and the same lengths L1 and L2.

In the present embodiment, in view of obtaining uniform electric field distribution near the top surface of the wafer W, the center Op of each of the openings 36a to 36d lies on any one of two concentric circles about the center O of the wafer W which have different diameters smaller than the wafer W, as shown in FIG. 5. At this time, all of the centers Op of the openings 36a to 36d are not located on the same circumference. In the present embodiment, as shown in FIG. 5, two openings 36a and 36c are disposed on the circumference of a radius R_{IN}, and the other openings 36b and 36d are disposed on the circumference of a radius R_{OUT} greater than the radius R_{IN}.

As shown in FIG. 5, the long sides and the short sides of the openings 36a to 36d are in parallel to the inner surfaces of the sidewall 20. FIG. 5 shows the state in which the long sides of the two openings 36a and 36c are in parallel to the sidewall 20 in the Y direction and the long sides of the other two openings 36b and 36d are in parallel to the sidewall 20 in the X direction.

Each of the openings 36a to 36d is disposed so as not to interfere with the other openings when shifting it in a direction perpendicular to the long sides. For example, even if the opening 36a shown in FIG. 5 is shifted in a direction perpendicular to the long side, i.e., in the X direction, the opening 36a does not interfere with the openings 36b and 36d as well as the opening 36c. By arranging the openings 36a to 36d in a substantially cross shape under such conditions, the microwave, irradiated through each of the openings 36a to 36d with strong directivity in a direction perpendicular to the long side, and the reflected wave thereof can be prevented from entering the other openings 35a to 36d. As a result, the loss caused by the microwave and the reflected wave entering the other openings 36a to 36d can be suppressed, and the effective heat treatment using the microwave can be carried out.

Further, in the present embodiment, the centers Op of two openings that are not circumferentially adjacent to each other among the openings 36a to 36d arranged in the substantially cross shape are not positioned on the same straight line parallel to the central line M. For example, the centers Op of the openings 36a and 36c whose long sides are arranged in the same direction are deviated from the central axis M in the opposite directions by a predetermined distance. By arranging the openings 36a and 36c in the above-described manner, it is possible to prevent the microwave irradiated in a direction perpendicular to the short sides of each of the openings 36a and 36c from entering the other opening 36a or 36c and suppress the occurrence of power loss. Further, as long as the centers Op of the openings 36a and 36c are not positioned on the same straight line, any one of the centers Op of the openings may lie on the central line M. The arrangement of the openings 36a to 36d is not limited to that of the present embodiment and may be arbitrarily set as long as the above-described relationship is satisfied.

The control unit 14 has a storage unit 60 and a temperature control unit 61. The control unit 14 controls each unit of the microwave heating apparatus 1 based on the recipe stored in the storage unit 60. The temperature control unit 61 controls the temperature of the wafer W by controlling the temperature of the coolant cooled by the coolant supply unit 34 or the flow rate of the coolant supplied from the coolant supply unit 34 to the coolant channel 35 based on the measurement result of the temperature measurement unit 26. Further, the instruction to the control unit 14 is executed by a dedicated control device or a CPU (not shown) for executing a program. The recipe in which processing conditions are set is previously stored in a ROM or a non-volatile memory (all not shown), and the CPU executes the recipe by reading out the conditions of the recipes from the memory.

The microwave heating apparatus 1 of the present embodiment is configured as described above. Hereinafter, the heat treatment of the wafer W by the microwave heating apparatus 1 will be described.

In order to perform the heat treatment on the wafer W, first, the gate valve 23 is opened and the wafer W is loaded into the processing chamber 10 by a transfer unit (not shown). The loaded wafer W is mounted on the supporting pins 32. Next, the gate valve 23 is closed, and the inside of the processing chamber 10 is exhausted by the gas exhaust unit 30 and set to a depressurized atmosphere. Then, a processing gas is supplied at a predetermined flow rate from the gas supply unit 12 into the processing chamber 10. At the same time, a coolant of a predetermined temperature is supplied from the coolant supply unit 34 to the coolant channel 35 through the shaft 31.

Next, a voltage is applied from the power supply unit 41 to the magnetron 42. The microwave generated by the magnetron 42 is transmitted through the waveguide 43 and is introduced into the processing space A in the processing chamber 10 through the transmission window 37. At this time, the shaft 31 is rotated by the driving unit 33, and the wafer W mounted on the supporting table 13 is rotated at a predetermined speed.

The microwave introduced into the processing chamber is irradiated to the surface of the wafer W, thereby heating the wafer W. At this time, the output of the irradiated microwave is adjusted, and the temperature of the wafer W is increased to a predetermined temperature. The wafer W is heated for a predetermined period of time.

While the wafer W is being heated for the predetermined period of time, the temperature of the wafer W is measured by the temperature measurement unit 26. The measurement result of the temperature measurement unit 26 is input to the control unit 14. In the temperature control unit 61, the temperature of the coolant supplied from the coolant supply unit 34 is controlled based on the measurement result such that the temperature of the wafer W is maintained at a constant level. The temperature control of the wafer W by the temperature control unit 61 is not limited to that of the present embodiment. For example, it is possible to control the coolant temperature to a constant temperature and control the flow rate of the coolant supplied from the coolant supply unit 34 to the coolant channel 35 in accordance with the temperature of the wafer W. Alternatively, it is possible to control both of the temperature and the flow rate of the coolant supplied to the coolant channel 35. Moreover, there may be used so-called cascade control for changing the flow rate or the temperature of the coolant supplied from the coolant supply unit 34 in accordance with the output of the microwave irradiated to the wafer W. Further, the temperature of the wafer W may be controlled by changing the height of the supporting table 13 by using the driving unit 33 to adjust the distance G between the wafer W and the transmission window 37. In that case, even if the distance G is changed, the supporting table 13, the coolant channel 35 and the coolant flowing in the coolant channel 35 neither absorbs nor reflects the microwave. Thus, even if the height of the supporting table 13 is changed, the electric field distribution of the processing space A is stably maintained. Accordingly, even if the height of the supporting table 13 is changed to control the temperature of the wafer W, the heat treatment can be stably performed.

When the heat treatment of the wafer W by the microwave is completed, the application of the voltage from the power supply unit 41 to the magnetron 42 is stopped, and the introduction of the microwave into the processing chamber 10 is stopped. At the same time, the operation of the driving unit 33 is stopped and the rotation of the wafer W is stopped. Further, the supply of the processing gas from the gas supply unit 12 and the supply of the coolant from the coolant supply unit 34 are stopped. Thereafter, the gate valve 23 is opened and the wafer W is unloaded to the outside of the processing chamber 10. Accordingly, a series of heat treatments for the wafer W is completed.

In accordance with the above embodiment, the supporting table 13 is made of quartz in which the product of the relative dielectric constant and the dielectric loss angle is smaller than 0.005, so that the temperature increase of the supporting table 13 by the dielectric heating of the microwave is suppressed to a minimum. Since the coolant flowing in the coolant channel 35 formed in the supporting table 13 is a fluorine organic liquid having no electrical polarity, the temperature increase of the coolant by the dielectric heating can be suppressed to a minimum. Accordingly, in the microwave heating apparatus 1 of the present embodiment, the wafer W supported by the supporting table 13 can be effectively cooled by the coolant. As a result, in accordance with the microwave heating apparatus 1 of the present embodiment, it is not necessary to cool the wafer W by using a large amount of cooling gas as in the conventional case, and the wafer W can be heated at a low running cost.

Besides, since the coolant channel 35 is formed by cutting the inner portion of the supporting table 13, the heating of the coolant by the temperature increase of the coolant channel 35 by the dielectric heating does not occur.

When the cooling is performed by using a cooling gas as in the conventional case, due to a small heat capacity of the gas, a large amount of the cooling gas needs to be supplied into the processing chamber in order to cool the wafer W at a high speed. On the other hand, when the wafer W is cooled by cooling the supporting table 13 that supports the wafer W by using a coolant as in the present embodiment, the heat is exchanged with the supporting table 13 having a heat capacity larger than that of the cooling gas by radiant heat or direct heat conduction. Therefore, the wafer W can be rapidly cooled compared to the conventional cooling using the cooling gas. In that case, the control with good responsiveness can be obtained even when the temperature of the wafer W is controlled based on the temperature measured by the temperature measuring unit 26.

Further, the supporting table 13 made of quartz hardly affects the electric distribution in the processing chamber even if it is vertically moved in the processing chamber 10. Therefore, even when the supporting table 13 is moved to control the temperature of the wafer W, the wafer W can be stably heated.

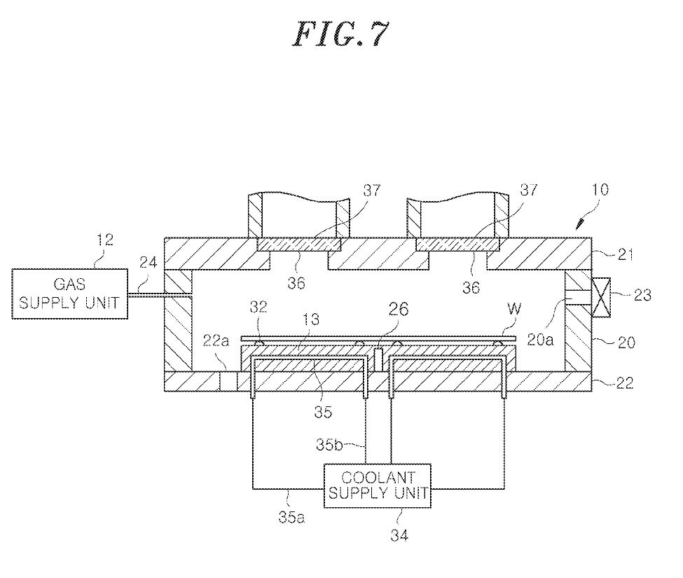

In the above-described embodiments, the supporting table 13 is supported by the shaft 31. However, when it is unnecessary to rotate the supporting table 13, for example, the shaft is not necessarily provided, and the supporting table 13 may be directly provided on the top surface of the bottom plate 22 as shown in FIG. 7. In that case, the coolant channel 35 and the coolant supply unit 34 are connected by a coolant supply line 35a and a coolant collecting line 35b penetrating through the bottom plate 22.

In the above-described embodiments, the entire supporting table 13 is made of quartz. However, at least the surface of the supporting table 13 which supports the wafer W may be made of quartz. In that case as well, the temperature increase of the wafer W by the dielectric heating of the supporting table 13 is suppressed to a minimum. In view of suppressing the temperature increase of the coolant by the dielectric heating, it is preferable that the region including the coolant channel 35 is made of quartz.

While the invention has been shown and described with respect to the embodiments, the present invention is not limited to the above-described examples. It will be understood by those skilled in the art that various changes and modification may be made without departing from the scope of the invention as defined in the following claims, and such modifications are also included in the technical scope of the present invention.

What is claimed is:

1. A microwave heating apparatus for performing heat treatment on a substrate to be processed by irradiating a microwave to the substrate in a processing chamber, comprising:
a supporting table configured to support the substrate in the processing chamber;
a microwave introducing unit configured to introduce the microwave into the processing chamber;
a coolant channel formed in the supporting table; and
a coolant supply source configured to supply a coolant to the coolant channel,
wherein at least a surface of the supporting table which supports the substrate is made of a material in which a product of a relative dielectric constant and a dielectric loss angle is smaller than 0.005; and
wherein the coolant supplied from the coolant supply source is liquid having no electrical polarity.

2. The microwave heating apparatus of claim 1, wherein the supporting table is made of a material having a heat resistance temperature of about 900° C. or above.

3. The microwave heating apparatus of claim 2, wherein the supporting table is made of quartz.

4. The microwave heating apparatus of claim 1, wherein the coolant channel is formed by cutting an inner portion of the supporting table.

5. The microwave heating apparatus of claim 1, further comprising:
a temperature measurement unit configured to measure a temperature of the substrate supported by the supporting table;
a temperature control unit configured to control at least one of a temperature and a flow rate of the coolant supplied to the coolant channel based on the measurement result of the temperature measurement unit.

6. The microwave heating apparatus of claim 5, wherein the temperature measurement unit is a non-contacting type thermometer.

7. The microwave heating apparatus of claim 1, further comprising a driving unit configured to rotate the supporting table.
